(19) United States
(12) Patent Application Publication
(10) Pub. No.: US 2009/0067701 A1
(43) Pub. Date: Mar. 12, 2009

(54) SYSTEM AND METHOD FOR DETECTING BLEMISHES ON SURFACE OF OBJECT

(75) Inventors: Po-Yuan Lai, Tu-Cheng (TW); I-Pen Chien, Tu-Cheng (TW); Hsin-Li Lin, Tu-Cheng (TW); Kuang-Wei Lin, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/018,755

(22) Filed: Jan. 23, 2008

(30) Foreign Application Priority Data
Sep. 7, 2007 (CN) 200710201620.1

(51) Int. Cl. G06K 9/00

(52) U.S. Cl. 382/141

(57) ABSTRACT

A system for detecting blemishes on a surface of an object includes at least an image capturing apparatus, at least a light source assembly, and a data processing device. The image capturing apparatus is configured for an image of a surface of an object and acquiring a brightness value of each of pixels of the image. The light source assembly is configured for light the surface. The data processing device is electrically connected to the image capturing apparatus and configured for calculating sum of all of the brightness value to obtain a mean value of the brightness values, comparing the brightness value of each pixel with the mean value and marking the pixels as a blemish whose brightness value is greater than the mean value. The system and method avoid errors that may otherwise occur due to the interference of noise, and avoid the subjective factors of viewers.

### RELATED FIELD

The present invention relates to optical detection technology, and more particularly, to a system and a method for detecting blemishes on a surface of an object such as an optical element.

### BACKGROUND

With the ongoing development of science and technology, portable electronic devices, such as mobile telephones, personal digital assistants (PDAs) and the like are now in widespread use. A number of optical elements for imaging, such as lenses, filters, and the like, may be employed in these electronic devices. If these optical elements have blemishes that obstruct or distort light, the resulting image is of bad quality. These blemishes are classified into three different types: dust, which can be removed by cleaning; scratches, which are usually long and narrow; and pits, which are usually small and more circular in nature. When these blemishes are on light sensing elements such as an image sensor package, undesired shadows will be cast on the image sensor package, and thus artifacts appear in the resulting image. Two popular kinds of image sensor packages are charge coupled device image sensor packages and complementary metal oxide semiconductor image sensor packages. Generally, a set of image sensor package is assembled into a final product, such as a digital camera.

Scratches, pits, and dust are typically created during the process of packaging each of the image sensor packages, and during handling the image sensor packages before the image sensor packages are assembled in the final product. In the past, the detection of blemishes has been done under a microscope or by viewing an image generated on a screen. These highly manual detection techniques are subjective, time consuming, and often inaccurate.

It is desired to provide a system for detecting blemishes on a surface of an object which can overcome the above-described deficiencies.

### SUMMARY

According to the present invention, a system for detecting blemishes on a surface of an object includes at least an image capturing apparatus, at least a light source assembly, and a data processing device. The image capturing apparatus is configured for capturing an image of an object and acquiring a brightness value of each pixel of the image. The light source assembly is configured for lighting the surface. The data processing device is electrically connected to the image capturing apparatus and configured for summing the brightness values and calculating a mean value of the brightness values, comparing the brightness value of each pixel with the mean value and indicating each pixel as blemishes whose brightness values are greater than the mean value.

Other novel features and advantages will become more apparent from the following detailed description when taken in conjunction with the accompanying drawings.

### BRIEF DESCRIPTION OF THE DRAWINGS

The present invention is described in detail hereinafter, by way of example and description of preferred and exemplary embodiments thereof and with reference to the accompanying drawings, in which:

FIG. 1 is a schematic diagram of configuration of a system for detecting blemishes on a surface of an object in accordance with an exemplary embodiment of the present invention, together with the object; and

FIG. 2 is a flow chart of an exemplary method for detecting blemishes on the surface of the object, utilizing the system of FIG. 1.

### DETAILED DESCRIPTION OF THE PREFERRED EMBODIMENTS

A detailed explanation of a system and method for detecting blemishes on a surface of an object according to embodiments of the present invention will now be made with reference to the drawings attached hereto.

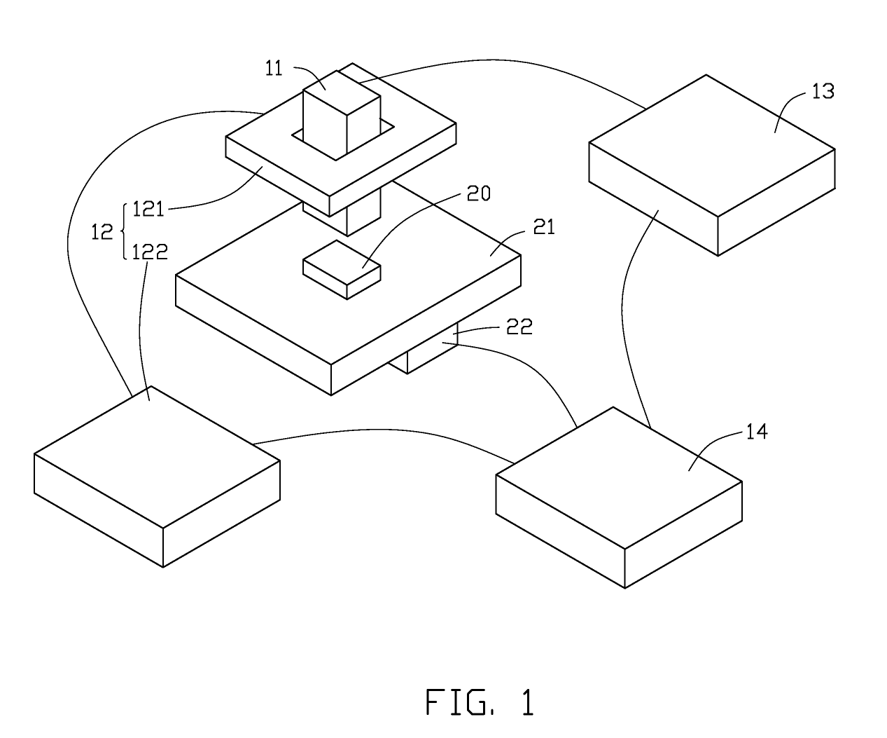

Referring to FIG. 1, a system for detecting blemishes on a surface of an object according to an exemplary embodiment of the present invention is shown. The system includes at least an image capturing apparatus 11, at least a light source assembly 12 electrically connected to the image capturing apparatus 11, a data processing device 13, and a main controller 14 electrically connected to the data processing device 13 and the light source assembly 12, respectively.

It should be noted that a detected object 20 in the present embodiment can be a glass lens plate or a filter. The object 20 is placed on a platform 21. The platform 21 is connected to a driver mechanism 22 such that the platform 21 can be moved along the xy-plane, thus selectively positioning the object 20. The main controller 14 is electrically connected to the driver mechanism 22 and controls the driver mechanism 22 to work.

The image capturing apparatus 11 can be a camera module, and is disposed on a base (not shown). The image capturing apparatus 11 is configured for capturing an image of the object 20, acquiring a brightness value of each pixel of the image, and sending the brightness values to the data processing device 13. In the present embodiment, if an area captured by the image capturing apparatus 11 is substantially equal to that of a surface of interest of the object 20, then the object 20 need only be positioned once. However, if the area captured by the image capturing apparatus 11 is less than that of the surface of interest of the object 20, the object 20 can be repositioned by the platform 21, and thus multiple images can be captured by the image capturing apparatus 11. Alternatively, it can be understood that several image capturing apparatuses may be employed in the system to simultaneously capture multiple images of the object 20.

It should be noted that the image capturing apparatus 11 can also be mounted on a movable arm (not shown) connected to a driver mechanism (not shown) such that the image capturing apparatus 11 can be selectively positioned relative to the object 20.

The light source assembly 12 includes a light source 121 and a light controller 122 electrically connected to the light source 121. The light source 121 can be a Helium-neon (He—Ne) laser, and is configured for lighting the surface of interest of the object 20. The light controller 122 is configured for controlling the brightness of the light emitted from the light source 121 to a desired level. It can be understood that a number of light sources may be employed to properly light the object 20.

The data processing device 13 is electrically connected to the image capturing apparatus 11. The data processing device 13 is configured for summing the brightness values, calculating a mean value of the brightness values, and comparing the brightness values of each pixel with the mean value. In this embodiment, the mean value is an arithmetic mean. The data processing device 13 is also configured for indicating certain of the pixels as representing blemishes, when the brightness values of such pixels are greater than the mean value.

The main controller 14 can be a computer, and is electrically connected to the light controller 122 and the data processing device 13; or in other embodiments, the main controller 14 may includes the light controller 122 and the data processing device 13 therein. It should be noted that the voltage supplied for the light source 121 can be supplied directly by the main controller 14, and the brightness of the light emitted by the light source 121 is also controlled by the main controller 14.

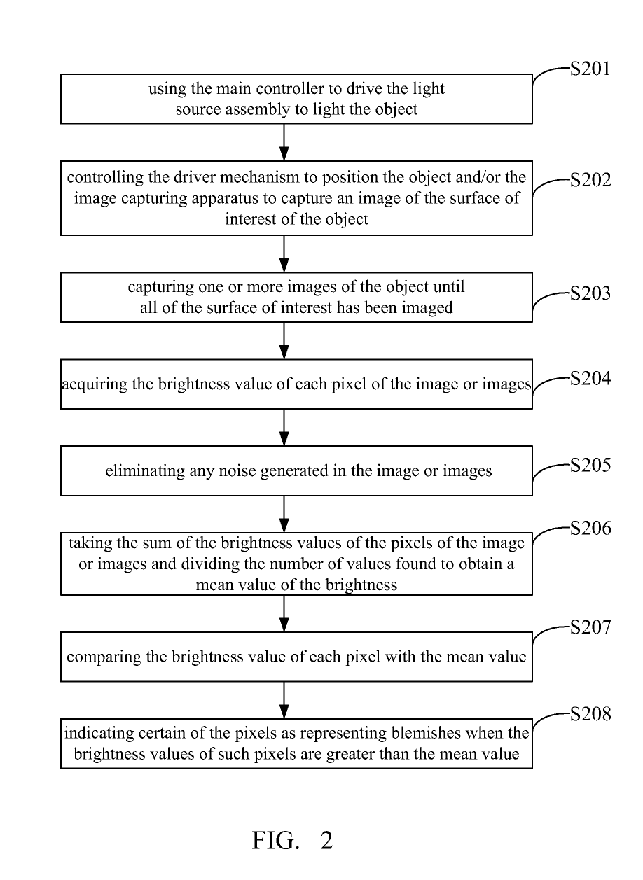

Referring to FIG. 2, a flow chart of an exemplary method for detecting blemishes on the surface of the object 20 is shown. The method includes:

step S201: using the main controller 14 to drive the light source assembly 12 to light the object 20;

step S202: controlling the driver mechanism 22 to position the object 20 and/or the image capturing apparatus 11 to capture an image of the surface of interest of the object 20;

step S203: capturing one or more images of the object 20 until all of the surface of interest has been imaged;

step S204: acquiring the brightness value of each pixel of the image or images;

step S205: eliminating any noise generated in the image or images;

step S206: taking the sum of the brightness values of the pixels of the image or images and dividing the number of values found to obtain a mean value of the brightness;

step S207: comparing the brightness value of each pixel with the mean value; and

step S208: indicating certain of the pixels as representing blemishes when the brightness values of such pixels are greater than the mean value.

In step S208, when the data processing device 13 finds a pixel whose brightness value is greater than the mean value, the data processing device 13 increases the brightness of the pixel in the image as viewed on a display screen (not shown). Thereby, a user can easily locate the blemish on the object 20.

In one embodiment of the above-described method, in step S204, the brightness values of the pixels are acquired one by one under the control of a program installed in the main controller 14. The brightness values for remaining unprocessed pixels continue to be acquired, until the last pixel is found and processed. A next process such as a cleaning process can be carried out after all the blemishes have been identified.

It should be noted that the above de-noise processing, mean brightness value calculation, and brightness value comparisons are automatically carried out by the data processing device 13, whereupon the data processing device 13 transmits the results to the main controller 14. This enables the user to determine whether to carry out a next process, and what such process should be. For example, the next process may be cleaning the object 20.

The system and method described above can accurately determine whether a pixel represents a blemish and indicate the location of the blemish, by cooperation of the image capturing apparatus 11, the data processing device 13, and the main controller 14. The system and method avoid errors that may otherwise occur due to the interference of noise, and avoid the subjective factors associated with human operators. Accordingly, the system and method can improve the efficiency and accuracy of blemish detection.

It should be understood that the above-described embodiment are intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. A system for detecting blemishes on a surface of an object, the system comprising:
at least an image capturing apparatus configured for capturing an image of an object and acquiring a brightness value of each pixel of the image;
at least a light source assembly configured for lighting the surface; and
a data processing device electrically connected to the at least an image capturing apparatus and configured for summing the brightness values, calculating a mean value of the brightness values, comparing the brightness value of each pixel with the mean value and indicating a pixel as a representing blemish of the surface when the brightness value of the pixel is greater than the mean value.

2. The system as claimed in claim 1, wherein the at lest an image capturing apparatus is a camera module.

3. The system as claimed in claim 1, further comprising a movable platform configured for supporting the object.

4. The system as claimed in claim 3, wherein the movable platform moves along xy-plane.

5. The system as claimed in claim 1, wherein at least a light source assembly comprises a light source and a controller electrically connected to the light source and configured for controlling the brightness of light emitted from the light source.

6. The system as claimed in claim 5, wherein the light source is a He—Ne laser.

7. The system as claimed in claim 1, further comprising a main controller electrically connected to the data processing device and the at least a light source assembly and configured for controlling the data processing device and the at least a light source assembly.

8. A method for detecting blemishes on a surface of an object, comprising:
lighting the object;
positioning at least one of the object and an image capturing apparatus relative to the other of the object and the image capturing apparatus;
capturing at least one image of the object until all of the surface has been imaged;
acquiring a brightness value of each pixel of the at least one image;
eliminating any noise generated in the at least one image;
taking the sum of the brightness values of the pixels of the at least one image and dividing the sum by the number of values found to obtain a mean value of brightness;
comparing the brightness value of each pixel with the mean value; and
indicating a pixel as representing a blemish of the surface when the brightness value are of the pixel is greater than the mean value.

9. The method as claimed in claim 8, further comprising eliminating noise generated in the at least one image after acquiring the brightness value of each pixel of the image via the at least an image capturing apparatus.
